(19) United States
(12) Patent Application Publication
(10) Pub. No.: US 2022/0234227 A1
(43) Pub. Date: Jul. 28, 2022

(54) Hair Clipper

(71) Applicant: Shenzhen DogCare Innovation & Technology Co., Ltd., Shenzhen (CN)

(72) Inventors: Yahua FAN, Shenzhen (CN); Yu LIU, Shenzhen (CN); Deqiang FAN, Shenzhen (CN)

(73) Assignee: Shenzhen DogCare Innovation & Technology Co., Ltd., Shenzhen (CN)

(21) Appl. No.: 17/447,935

(22) Filed: Sep. 17, 2021

(30) Foreign Application Priority Data
Jan. 26, 2021 (CN) 202120205872.7
Jun. 18, 2021 (CN) 202110680964.5

(51) Int. Cl. B26B 19/28; B26B 19/38; B26B 21/40; B26B 19/04

(52) U.S. Cl. CPC B26B 19/28; B26B 19/04; B26B 21/4087; B26B 19/3846

(57) ABSTRACT

A hair clipper includes a main body and a cutter head assembly. A motor is provided in the main body, and an eccentric shaft of the motor protrudes from a front end of the main body. The cutter head assembly includes a heat dissipation device, a stationary blade and a movable cutter assembly. The heat dissipation device includes a heat dissipation plate and a mounting structure, and a front side of the mounting structure is provided with a vertically communicated accommodation cavity. The stationary blade is fixed on a bottom plate of the mounting structure. The movable cutter assembly includes a torsion spring, a movable cutter base and a movable blade, the movable blade is fixed on the movable cutter base, a rear end of the movable cutter base is provided with a connection structure, the movable cutter assembly is disposed in the accommodation cavity.

### CROSS REFERENCE TO THE RELATED APPLICATIONS

This application is based upon and claims priority to Chinese Patent Applications No. 202120205872.7, filed on Jan. 26, 2021, and No. 202110680964.5, filed on Jun. 18, 2021, the entire contents of which are incorporated herein by reference.

### TECHNICAL FIELD

The present invention relates to the technical field of pet supplies, and more particularly, to a hair clipper.

### BACKGROUND

In the process of raising pets, for the health of the pets and to make the pets cuter, it is usually necessary to shear the hair of the pets regularly. Therefore, the hair clipper becomes an indispensable tool for grooming and raising pets.

At present, the commonly used hair clippers are electric hair clippers, which include a main body and a cutter head assembly. A motor is provided in the main body to drive an electric clipper head disposed in the cutter head assembly. During operation, the friction between a stationary blade and a movable blade increases the temperature of the electric clipper head, and therefore, a heat dissipation device is necessarily disposed on the cutter head assembly. However, in the prior art, the heat dissipation device is disposed on a cutter holder of the cutter head, which not only increases the complexity and cost of the structure of the cutter head, but also leads to the poor heat dissipation effect due to the small contact area between the heat dissipation device and the blades and the low heat conduction efficiency. In addition, due to the complex structure of the cutter head in the prior art, it is not conducive to mounting lights or other auxiliary elements on the hair clipper.

### SUMMARY

### I. Technical Problems to be Resolved

In view of the above-mentioned shortcomings and deficiencies of the prior art, the present invention provides a hair clipper, to resolve the technical problems of complex structure and poor heat dissipation effect of a cutter head of the existing hair clipper.

### II. Technical Solutions

To achieve the above objectives, the present invention mainly adopts the following technical solutions:

According to a first aspect, an embodiment of the present invention provides a hair clipper, including a main body and a cutter head assembly fixed on the main body; a motor is disposed in the main body, and an eccentric shaft of the motor protrudes from a front end of the main body;

the cutter head assembly includes a heat dissipation device, a stationary blade and a movable cutter assembly;

the heat dissipation device includes a heat dissipation plate and a mounting structure, the mounting structure is integrated with the heat dissipation plate, a rear side of the mounting structure is provided with a bottom plate, and a front side of the mounting structure is provided with a vertically communicated accommodation cavity;

the stationary blade is fixed on the bottom plate of the mounting structure;

the movable cutter assembly is disposed in the accommodation cavity, and the movable cutter assembly includes a torsion spring, a movable cutter base and a movable blade; the movable blade is fixed at a front end of the movable cutter base, a rear end of the movable cutter base is provided with a connection structure protruded upwardly, and comb fingers of the movable blade are in contact with comb fingers of the stationary blade;

the torsion spring is fixed on the mounting structure, both ends of the torsion spring are provided with pressure rods, and rear ends of the pressure rods are fixed on the movable blade and press the comb fingers of the movable blade to be in tight contact with the comb fingers of the stationary blade; and

the cutter head assembly is fixed at the front end of the main body, the eccentric shaft is movably matched with the connection structure of the movable cutter base, and drives the movable cutter base to swing left and right under the action of the motor to realize shearing actions of the movable blade and the stationary blade.

Optionally, a main control circuit board electrically connected to the motor is further disposed in the main body; and

the main control circuit board is provided with a power compensation module, and the power compensation module controls output power of the motor based on the resistance acting on the cutter head assembly during the shearing actions.

Optionally, the front end of the main body is provided with a light-emitting diode (LED) light, and a light control circuit board connected to the LED light is further disposed in the main body; and

the light control circuit board is provided with a brightness adjustment module and an environment brightness sensing module, and the brightness adjustment module automatically adjusts the brightness of the LED light based on brightness data sensed by the environment brightness sensing module.

Optionally, the light control circuit board is further provided with a display module, the display module includes a plurality of LED chips, and the LED chips are controlled by the light control circuit board to display at least one character, pattern or symbol for indicating a working state of the hair clipper; and

a housing of the main body is provided with a display panel corresponding to the display module, and the display panel is provided with a light-transmitting structure corresponding to the character, pattern or symbol.

Optionally, the light control circuit board is further provided with a working state indicator and a blade life indicator; and

each of the working state indicator and the blade life indicator is provided with a light pipe, and the housing is provided with a light-transmitting hole corresponding to the light pipe.

Optionally, the light control circuit board is provided with a smart mode button, and the smart mode button is configured to send a signal to the main control circuit board to turn on a smart selection function of a shear mode; or

the main control circuit board is provided with a gear switch, and the gear switch is configured to turn on or off the hair clipper and to control the output power of the motor through gear adjustment; or

the main control circuit board is further provided with a cutter head reset switch, and the cutter head reset switch is configured to reset, after the cutter head assembly is replaced, service life of the cutter head assembly displayed on the display module, or reset a display color of the blade life indicator; and

the housing of the main body is provided with button holes corresponding to the smart mode button, the gear switch and the cutter head reset switch, respectively.

Optionally, the heat dissipation plate is plate-shaped, and a front side surface of the heat dissipation plate is provided with a heat dissipation structure and a light-transmitting structure; and

an upper end of the heat dissipation plate is inclined towards the main body, and left and right walls of the heat dissipation plate extend backwards to be integrally connected to form the mounting structure with a top opening.

Optionally, the mounting structure includes a limiting portion and a fixing portion disposed on the bottom plate;

the fixing portion is provided with two limiting grooves with openings facing the heat dissipation plate, and a clamping groove is disposed between the two limiting grooves;

the limiting portion is disposed on a front side of the fixing portion;

the torsion spring includes two torsion portions, ends of the two torsion portions adjacent to each other are connected by a U-shaped rod, ends of the two torsion portions far away from each other are respectively provided with the pressure rods, and the pressure rods are perpendicular to the two torsion portions; and

the two torsion portions are respectively placed in the two limiting grooves, the U-shaped rod is clamped in the clamping groove, the two pressure rods are respectively located on two sides of the limiting portion, and displacements of left and right swing of the two pressure rods are limited by the limiting portion.

Optionally, a cutter head fixing plate is further disposed on an outer side of the front end of the main body, and each of both sides of the cutter head fixing plate is provided with an elastic piece, a through hole is disposed between two elastic pieces, and the eccentric shaft penetrates out of the through hole and is movably matched with the connection structure of the movable cutter base; and

the mounting structure is further provided with an elastic piece clamping groove matched with the elastic piece.

Optionally, an upper surface of the stationary blade is tightly attached to a bottom surface of the mounting structure, and the upper surface of the stationary blade and the bottom surface of the mounting structure are both smooth planes.

### III. Advantages

The present invention has the following advantages:

1. The stationary blade and the movable cutter assembly are directly mounted on the heat dissipation device. Compared with the prior art, this not only increases a contact area between the blades and the heat dissipation device, realizes a good heat dissipation function, but also reduces the cutter holder of the cutter head assembly in the prior art, which simplifies the structure of the cutter head assembly and reduces the production cost.

2. The cutter head assembly is fixed to the main body by the elastic pieces for easy disassembly.

3. The LED light and the light control circuit board are provided to facilitate use of the hair clipper in the case of low ambient light, and adjusting the brightness of the LED light based on the ambient brightness.

4. The display module or indicator is provided to display the working state of the hair clipper through the character, symbol or pattern.

5. Different shear modes are provided, and the power compensation module is disposed on the main control circuit board. When the smart selection function of a shear mode is turned on, the power compensation module can adjust the motor power in real time based on load of the cutter head assembly. This avoids the following problem: When the motor works at high power and high speed under low load, useless power is generated, thereby increasing the energy loss of the battery, shortening the service life of cutter head assembly and increasing frictional heat. In addition, unsmooth shearing is avoided when the motor works at low power and low speed under high load.

### BRIEF DESCRIPTION OF THE DRAWINGS

FIG. 1 is a schematic perspective view of Embodiment 1 of a hair clipper according to the present invention;

FIG. 2 is a schematic exploded view of the hair clipper in FIG. 1;

FIG. 3 is a schematic perspective view of a front end of a cutter head assembly in FIG. 1;

FIG. 4 is a schematic perspective view of a rear end of the cutter head assembly in FIG. 3;

FIG. 5 is a schematic side view of the cutter head assembly in FIG. 3;

FIG. 6 is a schematic exploded view of the cutter head assembly in FIG. 4;

FIG. 7 is a schematic perspective view of Embodiment 2 of a hair clipper according to the present invention;

FIG. 8 is a schematic exploded view of the hair clipper in FIG. 7;

FIG. 9 is a graph showing a relationship between a working time of a rechargeable hair clipper in the prior art and a temperature of a cutter head;

FIG. 10 is a graph showing a relationship between a working time of a plug-in hair clipper in the prior art and a temperature of a cutter head; and

FIG. 11 is a graph showing a relationship between a working time of a hair clipper of the present invention and a temperature of a cutter head.

### REFERENCE NUMERALS

10: cutter head assembly; 100: heat dissipation device; 110: heat dissipation plate; 120: mounting structure; 121: limiting portion; 122: fixing portion; 1221: limiting groove; 123: accommodation cavity; 124: buckle; 200: stationary blade; 300: movable cutter assembly; 310: movable cutter base; 320: movable blade; 321: pressure rod fixing hole; 330: torsion spring; 331: torsion portion; 332: U-shaped rod; 333: pressure rod; 40: main body; 410: cutter head fixing plate; 411: elastic piece; 420: motor; 421: eccentric shaft; 430: LED light; 440: light control circuit board; 441: display module; 442: smart mode button; 450: main control circuit board; 451: gear switch; 452: cutter head reset switch; 453: charging plugboard; 460: battery; 471: upper cover; 4711: display panel; 472: lower cover; 473: handle housing; 481: blade life indicator; 482: power indicator; 483: working mode indicator.

### DETAILED DESCRIPTION OF THE EMBODIMENTS

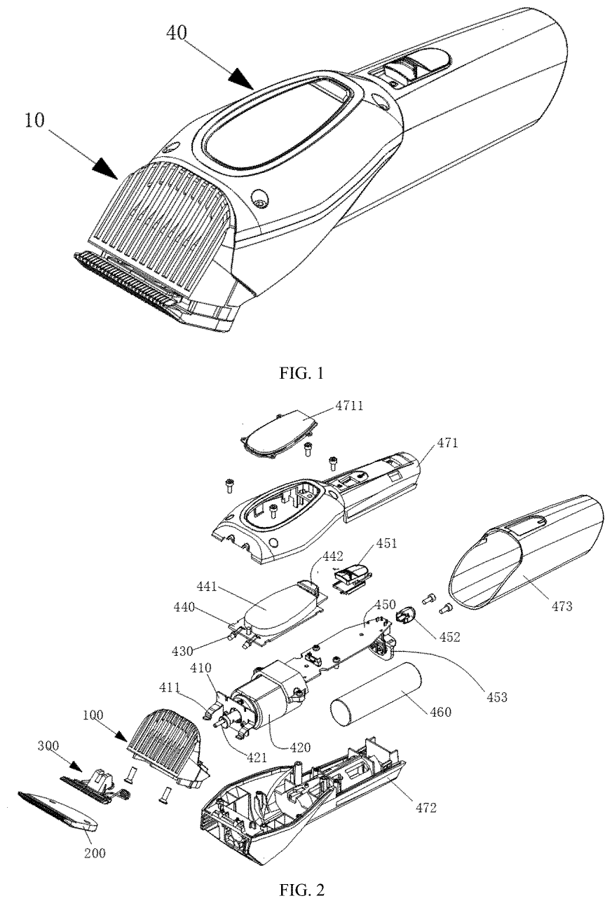

To facilitate better understanding of the present invention, the present invention will be described in detail below in conjunction with the accompanying drawings and through specific examples. Azimuth terms such as “front”, “rear”, “upper”, “lower” mentioned in this specification are based on orientations in FIG. 1. A direction facing a cutter head assembly is defined as “front”, and a direction facing a main body 40 is defined as “rear”.

A hair clipper provided in an embodiment of the present invention includes a main body and a cutter head assembly fixed on the main body; a front end of the main body is provided with an LED light, a motor is disposed in the main body, and an eccentric shaft of the motor protrudes from eth front end of the main body;

the cutter head assembly includes a heat dissipation device, a stationary blade and a movable cutter assembly;

the heat dissipation device includes a heat dissipation plate and a mounting structure, the mounting structure is connected to the heat dissipation plate, a rear side of the mounting structure is provided with a bottom plate, and a front side of the mounting structure is provided with a vertically communicated accommodation cavity;

the stationary blade is fixed on the bottom plate of the mounting structure;

the movable cutter assembly is disposed in the accommodation cavity, and the movable cutter assembly includes a torsion spring, a movable cutter base and a movable blade; the movable blade is fixed at a front end of the movable cutter base, a rear end of the movable cutter base is provided with a connection structure protruded upwardly, and comb fingers of the movable blade are in contact with comb fingers of the stationary blade;

the torsion spring is fixed on the mounting structure, both ends of the torsion spring are provided with pressure rods, and rear ends of the pressure rods are fixed on the movable blade and press the comb fingers of the movable blade to be in tight contact with the comb fingers of the stationary blade; and

the cutter head assembly is fixed at the front end of the main body, the eccentric shaft is movably matched with the connection structure of the movable cutter base, and drives the movable cutter base to swing left and right under the action of the motor to realize shearing actions of the movable blade and the stationary blade.

In the hair clipper of this embodiment, through the cutter head assembly, the stationary blade and the movable cutter assembly are directly mounted on the heat dissipation device. Compared with the prior art, this not only increases a contact area between the blades and the heat dissipation device, realizes a good heat dissipation function, but also reduces the cutter holder of the cutter head assembly in the prior art, which simplifies the structure of the cutter head assembly and reduces the production cost. In addition, the LED light is provided to facilitate use of the hair clipper in the case of low ambient light.

For better understanding of the above technical solutions, exemplary embodiments of the present invention will be described below in more detail with reference to the accompanying drawings. Although the accompanying drawings show exemplary embodiments of the present invention, it should be understood that the present invention may be implemented in various forms and should not be limited to the embodiments set forth herein. On the contrary, the embodiments are provided to provide a clearer more and thorough understanding of the present invention, and the scope of the present invention can be fully conveyed to those skilled in the art.

### Embodiment 1

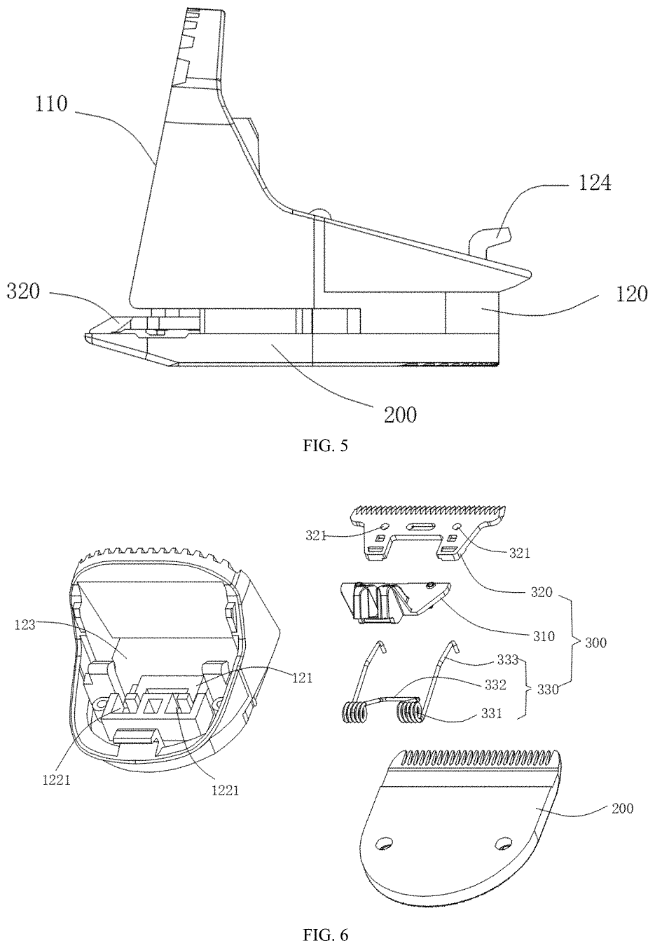

Referring to FIG. 1 to FIG. 6, the hair clipper of this embodiment includes a main body 40 and a cutter head assembly 10 fixed on a front side of the main body 40.

As shown in FIG. 3 to FIG. 6, the cutter head assembly 10 includes a heat dissipation device 100, a stationary blade 200 and a movable cutter assembly 300.

The heat dissipation device 100 includes a heat dissipation plate 110 and a mounting structure 120. The heat dissipation plate 110 is plate-shaped, and its upper end is inclined towards the main body 40, that is, inclined backwards. A front side surface of the heat dissipation plate 110 is provided with a heat dissipation structure and a light-transmitting structure. In practical applications, to improve the heat dissipation effect, the heat dissipation structure may be a wave-shaped or elongated heat dissipation fin. Open grooves may be disposed between heat dissipation fins to form a light-transmitting structure.

Left and right walls of the heat dissipation plate 110 extend backwards to be integrally connected to form the mounting structure 120 with a top opening. The mounting structure 120 has a bottom plate that is not completely closed, and the bottom plate is located on a rear side of the mounting structure 120, so that a vertically communicated accommodation cavity 123 is formed on a front side of the mounting structure 120. A part of the movable cutter assembly 300 is inserted into the accommodation cavity 123 from the lower side of the heat dissipation device 100.

In a feasible solution, the heat dissipation plate 110 and the mounting structure 120 can be integrally formed by aluminum alloy through die-casting.

The mounting structure 120 further includes a limiting portion 121 and a fixing portion 122 disposed on the bottom plate. The fixing portion 122 is provided with two limiting grooves 1221 with openings facing the heat dissipation plate 100, and the two limiting grooves 1221 are symmetrically arranged and spaced apart from each other. The limiting portion 121 is disposed on a front side of the fixing portion 122 and is a U-shaped portion with an opening facing the fixing portion 122. The limiting portion 121 includes a limiting base and limiting arms located on left and right sides of the limiting base, and the limiting arms are disposed in a one-to-one correspondence with the limiting grooves 1221 of the fixing portion 122.

In addition, a rear end and left and right sides of the mounting structure 120 may all be provided with buckles 124 to detachably fix the heat dissipation device 100 to the main body 40 of the hair clipper. The mounting structure 120 is further provided with an elastic piece clamping groove matched with the elastic piece 411 (described below) on a cutter head fixing plate 410.

A front end of the stationary blade 200 is provided with comb fingers. An upper surface of the stationary blade 200 is a smooth plane, and a lower surface is provided with a heat dissipation structure. The stationary blade 200 is fixed at the bottom of the mounting structure 120. Preferably, the bottom of the mounting structure 120 is a smooth plane, so that the upper surface of the stationary blade 200 is tightly attached to the bottom surface of the mounting structure 120.

The movable cutter assembly 300 includes a fixed member and a movable member. The movable member includes a movable cutter base 310 and a movable blade 320, and the fixed member includes a torsion spring 330. The movable cutter base 310 is provided with a movable blade fixing plate. A rear end of the movable blade fixing plate protrudes upward to form a protrusion. The protrusion is inserted into the accommodation cavity 123 from the lower side of the mounting structure 120. A rear side of the protrusion is provided a connection structure, and an eccentric shaft hole (or an eccentric shaft mounting groove) is provided on the connection structure for movably matching with the eccentric shaft 421. The movable blade 320 is fixed to a front end of the movable blade fixing plate by screws, and comb fingers of the movable blade 320 extend from the front end of the movable blade fixing plate to contact the comb fingers of the stationary blade 200. Pressure rod fixing holes 321 are provided behind the comb fingers of the movable blade 320. The torsion spring 330 has a left-right symmetric structure and includes two torsion portions 331. Ends of the two torsion portions 331 adjacent to each other are connected by a U-shaped rod 332, and ends far away from each other are respectively provided with the pressure rods 333.

The two torsion portions 331 of the torsion spring 330 are fixed in the limiting grooves 1221 of the fixing portion 122 in a one-to-one correspondence, and hooks at the ends of the pressure rods 333 are placed in the pressure rod fixing holes 321 on the movable blade 320. Under the action of the torsion spring 330, the comb fingers of the movable blade 320 are in tight contact with the comb fingers of the stationary blade 200. In this way, when driven by the movable cutter base 310 to move left and right, the movable blade 320 can cooperate with the stationary blade 200 to realize shearing actions.

In this embodiment, the movable cutter assembly 300 is disposed in the accommodation cavity 123 of the mounting structure 120, the movable blade 320 contacts the stationary blade 200, and the torsion spring 330 presses the movable blade 320 against the stationary blade 200 (that is, the torsion spring 330 prevents the movable cutter assembly 300 from moving up and down), so that the movable cutter assembly 300 is movably fixed on the mounting structure 120 under the combined action of the torsion spring 330 and the stationary blade 200, and can swing left and right under the drive of the eccentric shaft 421. To enable the pressure rods 333 of the torsion spring 330 to press the movable blade 320, a clamping groove is disposed between the two limiting grooves 1221 of the fixing portion 122. During assembly, the two torsion portions 331 are respectively placed in the limiting grooves 1221, the U-shaped rod 332 is clamped in the clamping groove, to prevent the torsion portion 331 from rotating, so that the pressure rods 333 always press the movable blade 320. In addition, the limiting portion 121 can limit left and right displacements of the torsion spring 330, thereby limiting displacements of left and right movement of the movable cutter base 310.

In some embodiments, the fixing portion 122 and the torsion spring 330 may alternatively adopt other structures according to actual needs, as long as the torsion spring 330 can press the movable blade 320.

In some embodiments, the stationary blade 200 may be fixed to the bottom of the heat dissipation device 100 in a variety of manners, such as by screws or buckles, as long as the upper surface of the stationary blade 200 is attached to and can be detached from the lower surface of the heat dissipation device 100.

In this embodiment, the contact surfaces of the stationary blade 200 and the mounting structure 120 are both smooth planes, which increases a contact area between the stationary blade 200 and the heat dissipation device 100. In addition, the heat dissipation structure is disposed on the lower surface of the stationary blade 200, which improves the heat dissipation effect. In some embodiments, in order to further improve the heat dissipation effect, a layer of thermally conductive adhesive may further be filled between the stationary blade 200 and the mounting structure 120.

In the cutter head assembly of this embodiment, the stationary blade and the movable cutter assembly are directly mounted on the heat dissipation device. Compared with the prior art, this not only increases the contact area between the blades and the heat dissipation device, realizes a good heat dissipation function, but also reduces the cutter holder of the cutter head assembly in the prior art, which simplifies the structure of the cutter head assembly and reduces the production cost.

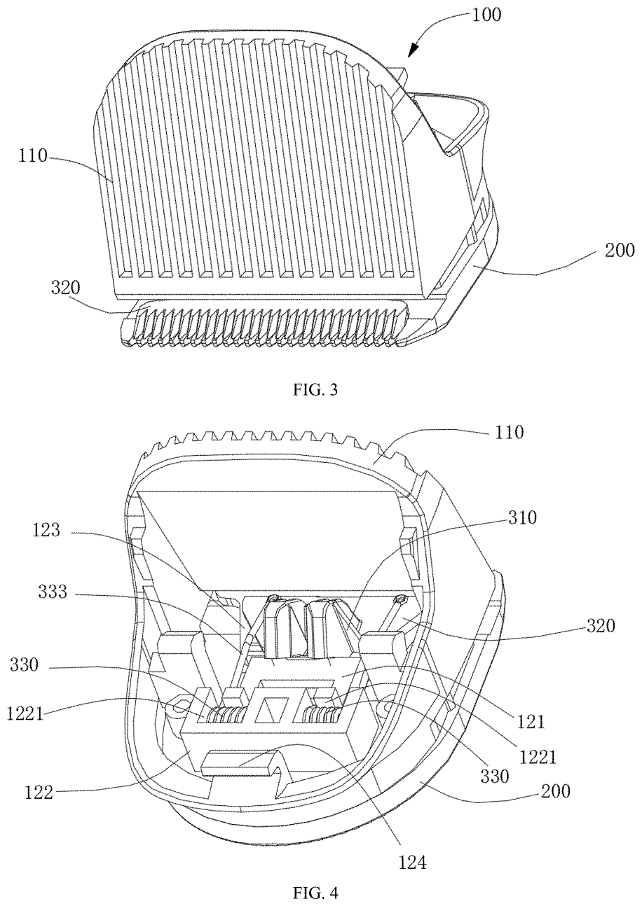

Still referring to FIG. 1 and FIG. 2, the main body 40 includes a housing, the cutter head fixing plate 410, a motor 420, an LED light 430, a light control circuit board 440, a display module 441, a main control circuit board 450 and a battery 460.

The cutter head fixing plate 410 is fixed on a front end of the motor 420. Each of both sides of the cutter head fixing plate 410 is provided with the elastic piece 411, and the elastic piece 411 extends away from the motor 420. The elastic piece 411 is clamped in an elastic piece clamping groove provided on the mounting structure 120 to fix the cutter head assembly on the front side of the main body 40.

The cutter head fixing plate 410 is further provided with a through hole located between the two elastic pieces 411, and the eccentric shaft 421 of the motor 420 penetrates out of the through hole.

The main control circuit board 450 is fixed behind the motor 420 and is electrically connected to the motor 420. The main control circuit board 450 is used to control the motor 420 and the light control circuit board 440. A gear switch 451 is disposed on an upper side of the main control circuit board 450. The gear switch 451 is configured to turn on or off the hair clipper, and may further be used to select a working mode of the hair clipper (for example, a silent working mode or a strong working mode). The gear switch 451 may be a key switch or a sliding switch, which may be set as required.

In practical applications, the gear switch 451 may be in electrical contact with the main control circuit board 450 through a gear switch elastic piece (for example, gold-plated beryllium bronze) to realize switch and gear adjustment.

In practical applications, the hair clipper may realize automatic gear shifting in the smart mode (described below). The power compensation module can adjust the power of the motor 420 into different gears in real time based on the load of the cutter head assembly. For example, a first gear is a silent working mode, and the power of the motor 420 is small; a second gear is a strong working mode, and the power of the motor 420 is large. When exiting the smart mode, if the gear switch 451 stays in the first gear, the motor 420 enters the silent working mode; if the gear switch 451 stays in the second gear, the motor 420 enters the strong working mode.

The rear end of the main control circuit board 450 is further provided with a cutter head reset switch 452. The cutter head reset switch 452 is configured to reset, after the cutter head assembly 10 is replaced, service life of the cutter head assembly 10 displayed on the display module 441, or reset a display color of the blade life indicator 481 (referring to FIG. 8).

In practical applications, the cutter head reset switch 452 may also be used to control the LED light 430. For example, clicking the cutter head reset switch 452 may turn on or off the LED light 430, and long pressing the cutter head reset switch 452 (for example, pressing for 5 seconds) realizes the reset function.

In practical applications, the blades (the stationary blade and the movable blade) of the hair clipper have certain service life. When the blades reach an upper limit of the service life after long time use, and are seriously worn, it is necessary to replace the cutter head assembly 10 or the blades. After replacement, the cutter head reset switch 452 is configured to reset the service life of the cutter head assembly 10 or the blades, recount the working time of the blades, and reset the service life of the cutter head assembly 10 displayed on the display module 441 or reset the display color of the blade life indicator 481.

In practical applications, the power compensation module may be disposed on the main control circuit board 450, to control the power of the motor 420 based on the resistance acting on the blades during the shearing actions (that is, adjust the power of the motor 420 in real time based on the load of the cutter head assembly). For example, after the smart mode selection function is turned on, if the hair is dense, the resistance increases, and the power compensation module controls a working voltage of the motor at 3.4 V, increases the output power of the motor 420, and enters the strong working mode; if there are fewer hairs, the resistance decreases, the power compensation module controls the working voltage of the motor at 3.0 V, reduces the output power of the motor 420, and enters the silent working mode. The power compensation module avoids the following problem: When the motor 420 works at high power and high speed under low load, useless power is generated, thereby increasing the energy loss of the battery 460, shortening the service life of cutter head assembly 10 and increasing frictional heat. In addition, unsmooth shearing is avoided when the motor 420 works at low power and low speed under high load.

The light control circuit board 440 and the main control circuit board 450 may be electrically connected through an 8P connection line. The LED light 430 is electrically connected to the light control circuit board 440. The light control circuit board 440 may further be provided with an environment brightness sensing module and a brightness adjustment module. The environment brightness sensing module can automatically sense brightness data of the environment, and the brightness adjustment module adjusts the brightness of the LED light 430 based on the brightness data. The display module 441 is disposed on the light control circuit board 440. The display module 441 is provided with LED chips arranged in a matrix, and can light up different LED chips under the control of the light control circuit board 440, to display different characters, symbols or patterns for displaying working states of the hair clipper. The light control circuit board 440 is further provided with a smart mode button (SMART button) 442. The smart mode button 442 is disposed behind the display module 441 for turning on or off the smart mode selection function of the hair clipper.

In practical applications, the character, symbol or pattern displayed by the display module 441 may be used to display battery power, blade service life, working modes, and/or cutter head temperature prompts.

The housing of the main body 40 includes an upper cover 471, a lower cover 472 and a handle housing 473. The upper cover 471 and the lower cover 472 cooperate with each other to form a housing which is closed in the vertical direction. The cutter head fixing plate 410, the motor 420 and the light control circuit board 410 are located on a front side of the housing. The light control circuit board 410 is fixed on the upper cover 471 and located above the motor 420; the LED light 430 is fixed at a front end of the housing; the eccentric shaft 421 of the motor 420 and the elastic pieces 411 of the cutter head fixing plate 410 protrude from the front end of the housing; the elastic pieces 411 are clamped in the elastic piece clamping grooves provided on the mounting structure 120, to fix the cutter head assembly 10 on the front side of the housing; the eccentric shaft 421 is inserted into the eccentric shaft hole (or an eccentric shaft mounting groove) of the connection structure of the movable cutter base 310, to realize movable matching with the movable cutter base 310, and drives the movable cutter base 310 to swing left and right under the action of the motor 420, to realize the shearing actions of the movable blade 320 and the stationary blade 200. The main control circuit board 450 and the battery 460 are disposed on a rear side of the housing. The battery 460 is electrically connected to the main control circuit board 450 and is disposed under the main control circuit board 450.

In practical applications, the motor 420 may be fixed on a motor fixing frame, which may be disposed on the lower cover 472 or the upper cover 471 according to actual needs. The motor fixing frame may be plate-shaped, and an anti-vibration rubber ring may be further disposed between the motor fixing frame and the motor 420, to reduce vibration of the motor 420 and protect the motor 420.

The upper cover 471 is provided with a display panel 4711 corresponding to the display module 441, and the display panel 4711 is provided with a light-transmitting structure to make the character, pattern or symbol on the display module 441 visible. The upper cover 471 is further provided with button holes corresponding to the gear switch 451 and the cutter head reset switch 452, respectively.

The lower cover 472 is provided with a battery compartment for storing the battery 460.

The lower cover 472 and the upper cover 471 are further provided with buckle clamping grooves corresponding to the buckles 124 on the mounting structure 120. The buckles 124 are matched with the buckle clamping grooves, and the elastic pieces 411 are matched with the elastic piece clamping grooves on the mounting portion 120, to jointly fix the cutter head assembly 10 on the front side of the main body 40.

The handle housing 473 is sleeved over the rear portion of the housing to facilitate grasping the hair clipper, and is provided with a button hole corresponding to the gear switch 451.

In practical applications, the battery may be a rechargeable battery. In this case, the main control circuit board 450 is further provided with a charging plugboard 453 with a charging interface, and the housing and the handle housing 473 are provided with a charging hole corresponding to the charging interface.

In the hair clipper of this embodiment, the stationary blade and the movable cutter assembly are directly mounted on the heat dissipation device. Compared with the prior art, this not only increases a contact area between the blades and the heat dissipation device, realizes a good heat dissipation function, but also reduces the cutter base of the cutter head assembly in the prior art, which simplifies the structure of the cutter head assembly and reduces the production cost. The cutter head assembly is fixed to main body by the elastic piece clamping grooves and buckle clamping grooves for easy disassembly. The LED light is provided to facilitate use of the hair clipper in the case of low ambient light. The display module is provided, to display the working state of the hair clipper by using the character, symbol or pattern.

### Embodiment 2

A hair clipper of this embodiment is proposed based on Embodiment 1, in which the display module in Embodiment 1 is replaced with a working state indicator and a blade life indicator.

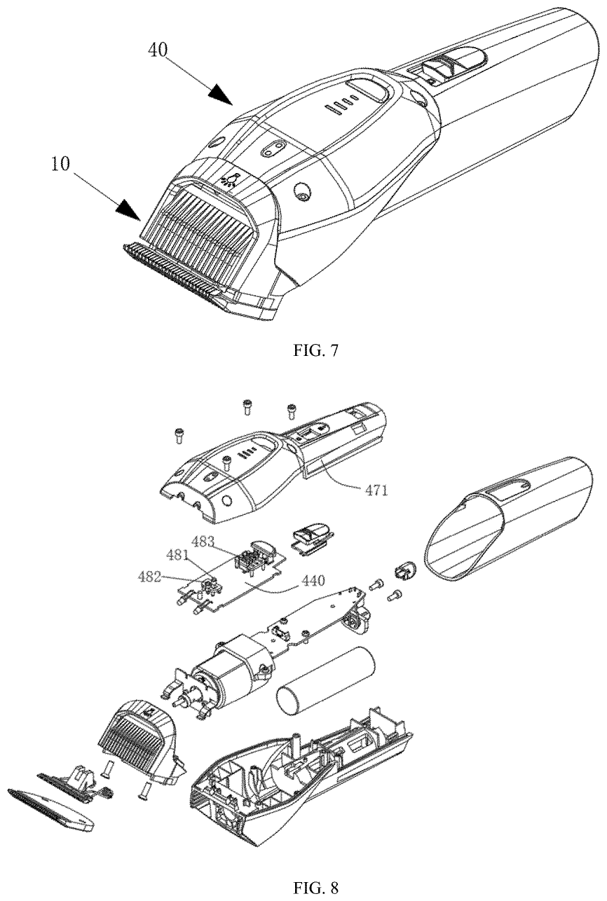

Referring to FIG. 7 and FIG. 8, in this embodiment, the working state indicator includes a power indicator 482 and a working mode indicator 483. The power indicator 482 and the blade life indicator 481 are disposed on the front side of the light control circuit board 440, and the working mode indicator 483 is disposed on the rear side of the light control circuit board 440. The working mode indicator 483 includes a plurality of indicators arranged side by side. Different numbers of lighted indicators indicate different working modes of the hair clipper. For example, when fewer indicators are lighted, it indicates a silent working mode. When all the working mode indicators are lighted, it indicates a strong working mode.

In practical applications, indication meanings of the working state indicator and the blade life indicator 481 may alternatively be defined as required. For example, for the battery indicator 482, always green indicates that the battery is fully charged; flashing green indicates that the battery is being charged; flashing red indicates that the battery is low; for the blade life indicator 481, red indicated that the blade needs to be replaced, and the indicator “off” indicates that the blade has not reached the end of its service life.

In this embodiment, each indicator is provided with a light pipe, and the upper cover 471 of the main body 40 is provided with the light-transmitting hole corresponding to the light pipe.

In the hair clipper of this embodiment, the stationary blade and the movable cutter assembly are directly mounted on the heat dissipation device. Compared with the prior art, this not only increases a contact area between the blades and the heat dissipation device, realizes a good heat dissipation function, but also reduces the cutter base of the cutter head assembly in the prior art, which simplifies the structure of the cutter head assembly and reduces the production cost. The main body and the cutter head assembly are fixed by elastic piece clamping grooves and buckle clamping grooves for easy disassembly. The LED light is provided to facilitate use of the hair clipper in the case of low ambient light. The working state indicators are provided, to display the working state of the hair clipper through the character, symbol or pattern.

In practical applications, the hair of pets or animals is long and dense, and the prior-art clipper is easy to get stuck and cannot work normally. Especially as the running time of the hair clipper is prolonged, the temperature of the cutter head rises rapidly due to friction, and the pets or animals may be even burned. In addition, the handle housing of the hair clipper is far away from the cutter head and has low thermal conductivity. Consequently, the user of the hair clipper cannot sense the temperature increase of the cutter head or even a high temperature during the shearing process. As a result, the pets or animals feel uncomfortable or even struggle because of injury during the shearing process, and cannot cooperate well with the owner to complete the hair shearing, but the pet or animal owner may not find the real problem. The structure of the heat dissipation device of the present invention conforms to the aerodynamic structure design. It can dissipate heat more effectively, and can prevent the cutter head from overheating during the shearing process. Therefore, there is no risk of harming the pets, and the pets are more cooperative during the shearing process.

The following will further describe the heat dissipation function of the hair clipper of the present invention by comparing test data of the existing hair clipper with test data of the hair clipper of the present invention.

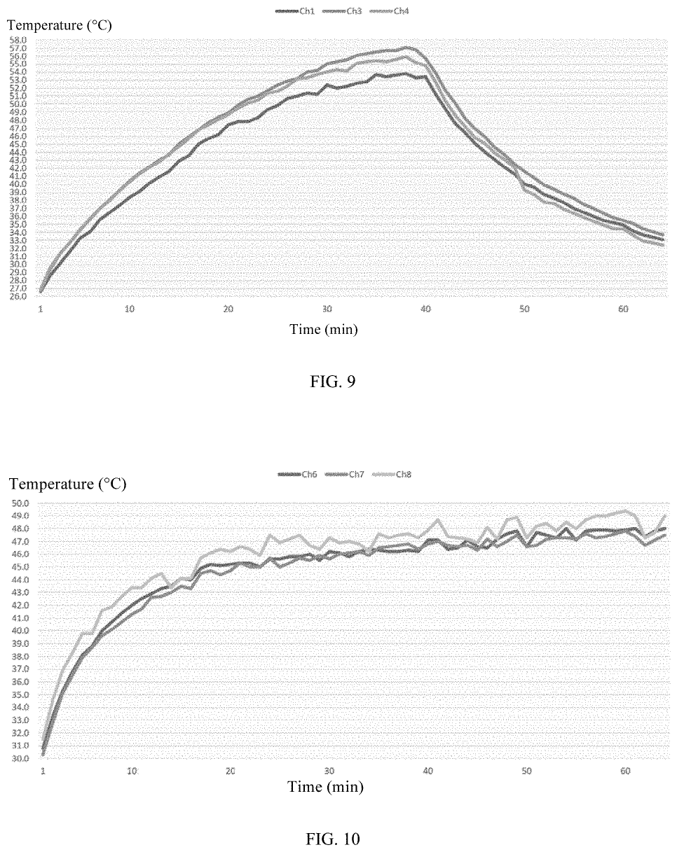

Specifically, for temperature test results of the prior-art hair clipper during use, refer to Table 1, FIG. 9 and FIG. 10. The test room temperature is 24° C. In a no-load mode of the hair clipper, temperatures of three different positions on the stationary blade are monitored in real time for 60 minutes, and the temperatures of the three test points are recorded every minute. Ch1, Ch3 and Ch4 are test data of different test points at a prior-art chargeable hair clipper, and Ch6, Ch7 and Ch8 are test data of different test points at another prior-art clipper powered by a socket.

TABLE 1

Temperature

| Time | Ch1 | Ch3 | Ch4 | Ch6 | Ch7 | Ch8 |
|---|---|---|---|---|---|---|
| 1 | 26.6 | 26.7 | 26.9 | 30.8 | 30.3 | 31.5 |
| 10 | 38.4 | 40.4 | 40.3 | 42.0 | 41.3 | 43.4 |
| 20 | 47.4 | 48.9 | 48.7 | 45.2 | 44.7 | 46.2 |
| 30 | 52.4 | 55.0 | 54.0 | 46.2 | 45.6 | 47.3 |
| 40 | 53.4 | 55.7 | 54.8 | 47.1 | 46.8 | 47.9 |
| 50 | 40.0 | 41.6 | 39.3 | 46.6 | 46.6 | 47.3 |
| 60 | 34.9 | 35.5 | 34.4 | 47.9 | 47.8 | 49.4 |

It can be learned from Table 1 and FIG. 9 that a temperature rise curve of the chargeable hair clipper is relatively fast. The temperature rises continuously within 40 minutes, and the maximum temperature is 57.1° C. When the power is depleted in 40 minutes, the hair clipper stops, and the temperature drops slowly. It can be learned from Table 1 and FIG. 10 that the plug-in hair clipper heats up faster in the first 15 minutes, and then slowly heats up, with a maximum temperature of 49.4° C.

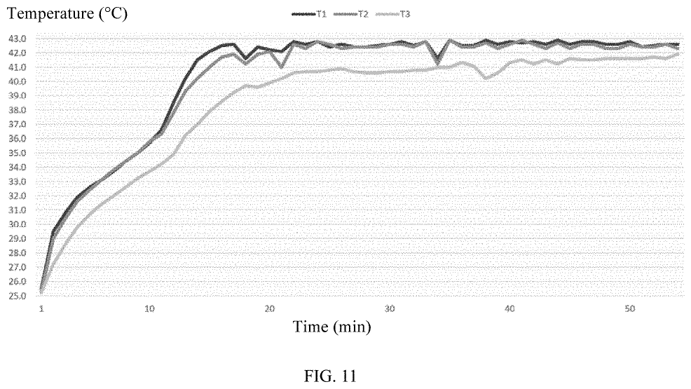

For the temperature test results of the hair clipper of the present invention during use, refer to Table 2 and FIG. 11. The test room temperature is 24° C. In a no-load mode of the hair clipper, temperatures of three different positions on the stationary blade are monitored in real time for 60 minutes, and the temperatures of the three test points are recorded every minute. T1, T2 and T3 are the temperatures of the three test points.

TABLE 2

| | Temperature | | |
|---|---|---|---|
| Time | T1 | T2 | T3 |
| 1 | 25.5 | 25.3 | 25.2 |
| 10 | 35.7 | 35.8 | 33.7 |
| 20 | 42.2 | 42.1 | 39.9 |
| 30 | 42.6 | 42.6 | 40.7 |
| 40 | 42.8 | 42.6 | 41.3 |
| 50 | 42.8 | 42.6 | 41.6 |
| 60 | 42.4 | 42.4 | 41.7 |

It can be learned from Table 2 and FIG. 11 that the temperature rise curve of the hair clipper of the present invention is relatively even, continuously rising from a room temperature of 24° C. to 42.9° C. 15 minutes later, the blade temperature stabilizes and remains at about 42° C.

Comparing Table 1 with Table 2 and comparing FIGS. 9 and 10 with FIG. 11, it can be learned that, compared with that of the prior-art hair clippers, the structure design of the heat dissipation device of the hair clipper of the present invention conforms to the aerodynamic structure design. Therefore, its temperature rises steadily, and it can dissipate heat well during the working process, so that the temperature of the blade of the hair clipper is maintained at about 42° C. This can prevent the cutter head from overheating during the shearing process, so there is no risk of harming the pets. The pets are more cooperative during the shearing process, achieving better user experience.

In the description of the present invention, it should be understood that terms such as “first” and “second” are used merely for a descriptive purpose, and should not be construed as indicating or implying a relative importance, or implicitly indicating the number of indicated technical features. Thus, features defined with “first” and “second” may explicitly or implicitly include one or more of the features. In the description of the present invention, “a plurality of” means two or more, unless otherwise specifically defined.

In the present invention, unless otherwise clearly specified, the terms “installation”, “interconnection”, “connection” and “fixation” etc. are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand specific meanings of the above terms in the present invention based on a specific situation.

In the present invention, it should be understood that terms such as “first” and “second” are used merely for a descriptive purpose, and should not be construed as indicating or implying a relative importance, or implicitly indicating the number of indicated technical features. In addition, that the first feature is “over”, “above”, and “on” the second feature includes that the first feature is directly above and diagonally above the second feature, or simply indicates that an altitude of the first feature is higher than that of the second feature. “A first feature is under and below a second feature” includes “the first feature is directly under or obliquely under the second feature” or simply means that “the first feature is lower than the second feature”.

In the description of the present specification, the description with reference to the terms “one embodiment”, “some embodiments”, “example”, “specific example”, or “some examples” means that specific features, structures, materials or characteristics described in connection with the embodiment or example are included in at least one embodiment or example of the present invention. In the present specification, the schematic representation of the above terms is not necessarily directed to the same embodiment or example. Furthermore, the specific features, structures, materials, or characteristics described may be combined in a suitable manner in any one or more of embodiments or examples. In addition, a person skilled in the art may combine different embodiments or examples described in this specification and characteristics of the different embodiments or examples without mutual contradiction.

Although the examples of the present invention have been illustrated and described above, it will be appreciated that the above examples are illustrative and should not be construed as limiting the scope of the present invention. Changes, modifications, substitutions and variations can be made to the above examples by a person of ordinary skill in the art within the scope of the present invention.

What is claimed is:

1. A hair clipper, comprising a main body and a cutter head assembly fixed on the main body, wherein
a motor is disposed in the main body, and an eccentric shaft of the motor protrudes from a front end of the main body;
the cutter head assembly comprises a heat dissipation device, a stationary blade and a movable cutter assembly;
the heat dissipation device comprises a heat dissipation plate and a mounting structure, wherein the mounting structure is integrated with the heat dissipation plate, a rear side of the mounting structure is provided with a bottom plate, and a front side of the mounting structure is provided with a vertically communicated accommodation cavity;
the stationary blade is fixed on the bottom plate of the mounting structure;
the movable cutter assembly is disposed in the vertically communicated accommodation cavity, and the movable cutter assembly comprises a torsion spring, a movable cutter base and a movable blade, the movable blade is fixed at a front end of the movable cutter base, a rear end of the movable cutter base is provided with a connection structure protruded upwardly, and comb fingers of the movable blade are in contact with comb fingers of the stationary blade;
the torsion spring is fixed on the mounting structure, both ends of the torsion spring are provided with pressure rods, and rear ends of the pressure rods are fixed on the movable blade and press the comb fingers of the movable blade to be in tight contact with the comb fingers of the stationary blade; and
the cutter head assembly is fixed at the front end of the main body, the eccentric shaft is movably matched with the connection structure of the movable cutter base, and the eccentric shaft drives the movable cutter base to swing left and right under an action of the motor to realize shearing actions of the movable blade and the stationary blade.

2. The hair clipper according to claim 1, wherein
a main control circuit board electrically connected to the motor is disposed in the main body; and
the main control circuit board is provided with a power compensation module, and the power compensation module controls an output power of the motor based on a resistance acting on the cutter head assembly during the shearing actions.

3. The hair clipper according to claim 2, wherein
the front end of the main body is provided with a light-emitting diode (LED) light, and a light control circuit board connected to the LED light is further disposed in the main body; and
the light control circuit board is provided with a brightness adjustment module and an environment brightness sensing module, and the brightness adjustment module automatically adjusts a brightness of the LED light based on brightness data sensed by the environment brightness sensing module.

4. The hair clipper according to claim 3, wherein
the light control circuit board is further provided with a display module, the display module comprises a plurality of LED chips, and the plurality of LED chips are controlled by the light control circuit board to display at least one character, pattern or symbol for indicating a working state of the hair clipper; and
a housing of the main body is provided with a display panel corresponding to the display module, and the display panel is provided with a light-transmitting structure corresponding to the at least one character, pattern or symbol.

5. The hair clipper according to claim 3, wherein
the light control circuit board is further provided with a working state indicator and a blade life indicator; and
each of the working state indicator and the blade life indicator is provided with a light pipe, and a housing of the main body is provided with a light-transmitting hole corresponding to the light pipe.

6. The hair clipper according to claim 4, wherein
the light control circuit board is provided with a smart mode button, and the smart mode button is configured to send a signal to the main control circuit board to turn on a smart selection function of a shear mode; or
the main control circuit board is provided with a gear switch, and the gear switch is configured to turn on or off the hair clipper and to control the output power of the motor through gear adjustment; or
the main control circuit board is further provided with a cutter head reset switch, and the cutter head reset switch is configured to reset, after the cutter head assembly is replaced, a service life of the cutter head assembly displayed on the display module, or reset a display color of the blade life indicator; and
the housing of the main body is provided with button holes corresponding to the smart mode button, the gear switch and the cutter head reset switch, respectively.

7. The hair clipper according to claim 1, wherein
the heat dissipation plate is plate-shaped, and a heat dissipation structure and a light-transmitting structure are provided on a front side surface of the heat dissipation plate; and
an upper end of the heat dissipation plate is inclined towards the main body, and left and right walls of the heat dissipation plate extend backwards to be integrally connected to form the mounting structure with a top opening.

8. The hair clipper according to claim 7, wherein
the mounting structure comprises a limiting portion and a fixing portion, wherein the limiting portion and the fixing portion are disposed on the bottom plate;
the fixing portion is provided with two limiting grooves with openings facing the heat dissipation plate, and a clamping groove is disposed between the two limiting grooves;
the limiting portion is disposed on a front side of the fixing portion;
the torsion spring comprises two torsion portions, wherein
first ends of the two torsion portions are adjacent to each other and are connected by a U-shaped rod,
second ends of the two torsion portions are far away from each other and are respectively provided with two pressure rods, and
the two pressure rods are perpendicular to the two torsion portions; and
the two torsion portions are respectively placed in the two limiting grooves, the U-shaped rod is clamped in the clamping groove, the two pressure rods are respectively located on two sides of the limiting portion, and displacements of left and right swing of the two pressure rods are limited by the limiting portion.

9. The hair clipper according to claim 1, wherein
a cutter head fixing plate is disposed on an outer side of the front end of the main body, and each of both sides of the cutter head fixing plate is provided with an elastic piece, a through hole is disposed between two elastic pieces, and the eccentric shaft penetrates out of the through hole and is movably matched with the connection structure of the movable cutter base; and
the mounting structure is further provided with an elastic piece clamping groove matched with the elastic piece.

10. The hair clipper according to claim 1, wherein
an upper surface of the stationary blade is tightly attached to a bottom surface of the mounting structure, and the upper surface of the stationary blade and the bottom surface of the mounting structure are smooth planes.

11. The hair clipper according to claim 5, wherein
the light control circuit board is provided with a smart mode button, and the smart mode button is configured to send a signal to the main control circuit board to turn on a smart selection function of a shear mode; or
the main control circuit board is provided with a gear switch, and the gear switch is configured to turn on or off the hair clipper and to control the output power of the motor through gear adjustment; or
the main control circuit board is further provided with a cutter head reset switch, and the cutter head reset switch is configured to reset, after the cutter head assembly is replaced, a service life of the cutter head assembly displayed on the display module, or reset a display color of the blade life indicator; and
the housing of the main body is provided with button holes corresponding to the smart mode button, the gear switch and the cutter head reset switch, respectively.
